(19) United States
(12) Patent Application Publication
(10) Pub. No.: US 2017/0112131 A1
(43) Pub. Date: Apr. 27, 2017

(54) METHODS FOR TREATING CITRUS FRUIT TREES

(71) Applicants: James C. Meadows, Auburn, AL (US); James William Garvin, Geneseo, IL (US); Paul A. Neese, Simpsonville, SC (US)

(72) Inventors: James C. Meadows, Auburn, AL (US); James William Garvin, Geneseo, IL (US); Paul A. Neese, Simpsonville, SC (US)

(21) Appl. No.: 15/335,995

(22) Filed: Oct. 27, 2016

Related U.S. Application Data
(60) Provisional application No. 62/247,047, filed on Oct. 27, 2015.
(60) Provisional application No. 62/296,384, filed on Feb. 17, 2016.

(51) Int. Cl. A01N 43/90; A01N 37/10; A01N 43/38

(52) U.S. Cl. CPC A01N 43/90; A01N 43/38; A01N 37/10

(57) ABSTRACT

A method to treat or prevent huanglongbing (HLB) in citrus plants is disclosed. The method comprises applying a composition containing an auxin and cytokinin to the citrus plant at least four times. Each application is at least 10 days but not more than 90 days from the previous application.

### CROSS REFERENCE TO RELATED APPLICATIONS

This application claims priority to Provisional Application No. 62/247,047, filed Oct. 27, 2015 and Provisional Application No. 62/296,384 filed Feb. 17, 2016, which are herein incorporated by reference in their entirety.

### BACKGROUND

Huanglongbing (HLB) or citrus greening is a disease which affects citrus plants or trees, including plants that produce lemons, oranges, limes and grapefruit. Early symptoms of citrus greening include yellow veining and asymmetrical chlorosis, or blotchy mottle, on the leaves. These symptoms may initially be contained to a single branch or shoot and may spread throughout the tree over the course of a year. The plant may experience twig dieback, causing the productivity of the plant to decline within a few years. The fruit of an infected plant are typically small in number and size, may be lopsided with a curved central core, may fail to color properly and may have a salty, bitter taste making them unsuitable for sale as fresh fruit or for juice. The root system of an infected plant may be poorly developed. Once infected, a plant typically dies within a few years.

While the disease poses no risk to humans and animals, the citrus greening disease has affected citrus production in a number of countries in North America (United States and Mexico), Asia, Africa, South America (i.e., Brazil) and the Arabian Peninsula. In the United States, the disease has been discovered in Florida, California and Texas, threatening American's citrus production.

The citrus greening disease is caused by bacteria which are transmitted by the Asian citrus psyllid. To date, three different bacteria species have been identified to cause HLB: Candidadus Liberibactera (Ca. L.) asiaticus, an Asian species; Ca. L. africanus, an African species; and Ca. L. americanus, an American species. The infected insect spreads the disease as it feeds on the leaves and stems of the citrus plants. There currently is no cure for citrus greening disease. In the United States, a public awareness campaign sponsored by the USDA, encourages people not to move citrus plants, wood and leaves.

### SUMMARY

A method of treating citrus plants is described herein. In some embodiments, the method includes applying a composition containing an auxin, such as indole-3-butryric acid (IBA), indole-3-acetic acid (IAA), and naphthalene-1-acetic acid (NAA), and a cytokinin to the citrus plant, and repeating the application step at least three additional times, wherein the applications are spaced at least 10 days but not more than 90 days apart.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is an illustrative test plot.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

A more complete understanding of the present invention is available by reference to the following detailed description of numerous aspects and embodiments of the invention. The detailed description of the invention which follows is intended to illustrate but not limit the invention.

As described herein, it was surprisingly found that multiple applications of a composition containing an auxin, such as indole-3-butryric acid (IBA), indole-3-acetic acid (IAA), and naphthalene-1-acetic acid (NAA), and a cytokinin, such as kinetin and 6-benzylaminopurine (BAP), to citrus greening or HLB infected citrus plants showed improvements compared to untreated infected citrus plants and infected citrus plants treated with other foliar micronutrients. For example, it was found that multiple applications of the composition increased the mean pounds of fruit harvested and the mean pound solids of the harvested fruit. The composition may also help protect citrus plants against infection of HLB and/or against the disease resulting from the infection.

In some embodiments, the composition may be formed by mixing a concentrate actives composition with water prior to application to the plant. The concentrate actives composition may include from about 0.2 wt % to about 2 wt % auxin, or from about 0.6 wt % to about 1wt % auxin, or about 0.85 wt % auxin, where the auxin is selected from IBA, IAA, NAA and combinations thereof. The concentrate actives composition may also include from about 0.05 wt % to about 0.5 wt % cytokinin, or from about 0.05 wt % to about 0.25 wt % cytokinin, or about 0.15 wt % cytokinin, wherein the cytokinin may be kinetin or BAP. In some embodiments, the concentrate actives composition may include from about 0.2 wt % to about 2 wt % auxin and from about 0.05 wt % to about 0.5 wt % cytokinin. In some embodiments, the concentrate actives composition may include from about 0.6 wt % to about 1 wt % auxin and from about 0.05 wt % to about 0.25 wt % cytokinin.

The concentrate actives composition may be mixed with water at a ratio of about 0.05 to about 0.5% volume concentrate to volume water to form the composition prior to application to the plant.

In some embodiments, one or more additives may be added to the water prior to mixing the water and the concentrate actives composition. Suitable additives can adjust the pH of the water and/or remove unwanted components such as aluminum, calcium and magnesium. For example, an additive may be added to the water to reduce the pH to about 7.0 or less, to about 6.0 or less, to about 7.0 to about 5.5, to about 6.0 to about 5.5, or to about 5.0 to 5.5.

In some embodiments, the concentrate actives composition or the composition may include one or more adjuvants. For example, the composition may include a drift reduction agent and/or a wetting agent, such as an organosilicone wetter. Example drift reduction agents include LI700® and example wetting agents include Hi-Wett®, both of which are available from Loveland Products, Loveland, Colo. In some embodiments, the composition may include from about 0.01% to about 0.5% volume wetting agent to volume water. In other embodiments, the composition may include from about 0.05% to about 0.3% volume wetting agent to volume water.

Additional components, including nutrients and micronutrients, may be added to the concentrate actives composition or the composition prior to application to the plants. In some embodiments, the concentrate actives composition or the composition may include at least one of phosphate, boron, magnesium, molybdenum, nitrogen, potash, copper, iron, manganese and zinc. For example, the concentrate actives composition or the composition may include at least one of nitrogen, potash, copper, iron, manganese and zinc or at least one of phosphate, boron and molybdenum.

In some embodiments, the concentrate actives composition and/or the composition may include active compounds consisting of at least one auxin and at least one cytokinin. That is, the concentrate actives composition and/or the composition may be free of active compounds, such as strobilurins, carboxamides, azoles, heterocyclic compounds, and carbamates, except for the at least one auxin and the at least one cytokinin. In some embodiments, the concentrate actives composition and/or the composition may consist or consist essentially of an auxin, a cytokinin, water and optionally one or more additives, adjuvants, nutrients and/or micronutrients.

In some embodiments, the composition may be applied as a foliar application to a citrus plant infected with the greening disease. For example, the composition may be mixed with water and applied as a liquid composition by spraying the composition onto the foliar of the infected plant. Alternatively, the composition may be applied to the soil immediately surrounding the infected plant such that the composition is taken up by the plant's root system. In some embodiments, the composition may be applied as a foliar application or to the soil at a rate of about 50 gallons per acre, about 45 gallons per acre, about 40 gallons per acre or about 35 gallons per acre.

In some embodiments, the composition may be applied to plants infected with or at risk of infection with HLB in a number of foliar applications. In other embodiments, the composition may be applied to plants infected with or at risk of infection with HLB in a number of soil applications. In some embodiments, the composition may be applied in a series of at least four, five, six or more applications. In some embodiments, at least 10 days but not more than 90 days or 60 days elapse between applications. In some embodiments, at least 10 days but not more than 40 days elapse between applications.

The applications may be applied at equal intervals. For example, each application may be applied approximately every 30 to 40 days. Alternatively, a first set of applications may be applied at a first frequency and a second set of applications may be applied at a second frequency. For example, two to four applications may be applied about every 30 days and the next two to four applications may be applied about every 90 days.

The composition may be applied to the plants infected with or at risk of infection with HLB during one or more events such as root flushing, summer drop, or flowering. Citrus plants, such as orange trees, may experience distinct bursts of root growth known as root flush. For example, three distinct cycles of root growth have been observed in mature trees growing in Arizona, California, and Florida. The first root flush in Florida usually occurs between late February and early April, the timing of which is regulated by prevailing environmental conditions. The timing of the two remaining flushes are inconsistent, varying considerably between years and trees, but may be seen during the periods of May through June and again during August through October. In some embodiments, the composition may be applied to plants infected with or at risk of infection with HLB during one or more root flushing periods.

### EXAMPLES

The present invention is more particularly described in the following examples that are intended as illustrations only, since numerous modifications and variations within the scope of the present invention will be apparent to those of skill in the art. Unless otherwise noted, all parts, percentages, and ratios reported in the following examples are on a weight basis.

The following commercially available products were used in the following examples. Each is available from Loveland Products, Loveland, Colo.

Radiate® (EPA Reg No. 34704-909): a plant growth product containing IBA and cytokinin and having the following composition:
Active Ingredients:
   0.85 wt % 3-indolebutryic acid (IBA)
   0.15 wt % cytokinin, as kinetin
Other Ingredients:
   99.00 wt % other ingredients

LI 700® (CA Reg. No. 34704-50035): a drift control agent containing phosphatidylcholine, methylacetic acid and alkyl polyoxyethylene ether and having the following composition:
Principal Functioning Agents:
   80 wt % phosphatidylcholine, methylacetic acid and alkyl polyoxyethylene ether
   20 wt % constituents ineffective as spray adjuvant

Hi-Wett® (CA Reg. No. 34704-50066): a wetting agent containing polysiloxane polyether copolymer, alcohol ethoxylate, polyoxyethylene-polyoxypropylene copolymer and having the following composition:
Principal Functioning Agents:
   100 wt % polysiloxane polyether copolymer, alcohol ethoxylate, polyoxyethylene-polyoxypropylene copolymer

NutriSync® D: a foliar nutrient containing phosphate, potash, boron and molybdenum and having the following guaranteed analysis:
2.00% available phosphate (P₂O₅)
1.00% soluble potash (K₂O)
0.70% boron (B)
0.90% molybdenum

NutriSync® Zn: a foliar nutrient containing nitrogen, potash, copper, iron, manganese and zinc and having the following guaranteed analysis:
13.00% total nitrogen
   4.6% ammoniacal nitrogen
   2.8% nitrate nitrogen
   5.6% urea nitrogen
1.00% soluble potash (K₂O)
0.12% chelated copper (Cu)
0.12% chelated iron (Fe)
2.00% chelated zinc (Zn).

### Trial 1

### Examples 1-3

Examples 1, 2 and 3 were formed by mixing the components with water as summarized in Table 1, where vol/vol denotes volume of component per volume water, pt/a is pint of component per acre, oz/a is ounce of component per acre.

TABLE 1

| | | NutriSync | NutriSync | | |
|---|---|---|---|---|---|
| | Radiate | D | Zn | LI 700 | Hi-Wett |
| Example 1 | 0.1% | | | 0.125% | 6 oz/a |
| | vol/vol | | | vol/vol | |
| Example 2 | | 1 pt/a | | 0.125% | 6 oz/a |
| | | | | vol/vol | |
| Example 3 | | | 2 pt/a | 0.125% | 6 oz/a |
| | | | | vol/vol | |

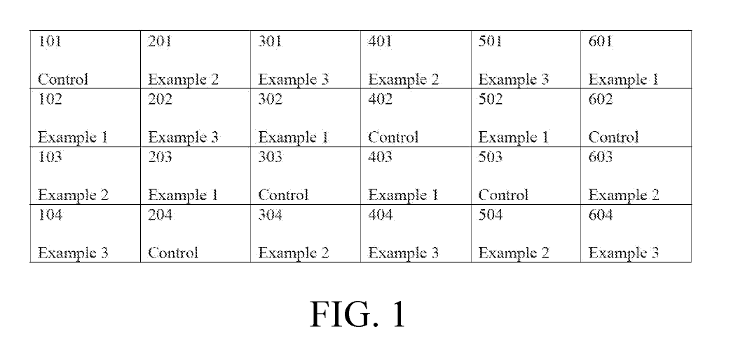

A 20 by 60 foot test plot of HLB infected Valencia orange trees was divided into 24 sections. Each Example was applied to six randomly designated sections. As a control, standard maintenance (i.e., standard fertilizer treatments) was applied to six of sections. An illustrative test plot is provided in FIG. 1. Each Example was applied at a rate of 50 gallons per acre to the infected plants in a series of applications according to the schedule of Table 2 using a foliar spray treatment. Certain of these applications were made during root flushing. In Table 2, days are calculated from Application 1. That is, Application 3 occurred 44 days from Application 1. At the first application (day 0), the plants had 5-10 mm fruit.

TABLE 2

| | | Air | % |
|---|---|---|---|
| | | temperature | relative |
| | Day | (F.) | humidity |
| Application 1 | 0 | 79 | 60 |
| Application 2 | +15 | 90.1 | 54 |
| Application 3 | +44 | 89.7 | 52 |
| Application 4 | +73 | 85 | 71 |
| Application 5 | +92 | 92 | 56 |
| Application 6 | +126 | 90.8 | 62 |
| Application 7 | +155 | 91 | 65 |
| Application 8 | +192 | 86 | 67 |
| Application 9 | +223 | 87.2 | 65 |
| Application 10 | +286 | 53.8 | 61 |
| Application 11 | +311 | 60.9 | 34 |
| Application 12 | +344 | 70.7 | 72 |

Vigor was determined on a scale of 1 to 5, where 1 was low vigor or no new growth and 5 was high vigor or large amount of growth. Vigor readings on a particular date were performed by the same individual and are comparative.

Trunk diameter was determined by measuring the trunk diameter at a marked designated location on the subject trunk. An increase in the trunk diameter indicates increased tissue growth. Root diameter was determined by measuring the diameter of the root with calipers.

Results are provided in Table 3. Trees treated with Example 1 showed improved vigor readings, decreased fruit drop, increased trunk diameter and increased root growth as compared to the control. Those who understand citrus production agree that trees treated with Example 1 appeared healthier and better than the control.

TABLE 3

| | | Example 1 compared to |
|---|---|---|
| Type | Timing | control |
| Vigor Reading | 1 day before Application 4 | No significant difference |
| Vigor Reading | 13 days after Application 4 | No significant difference |
| Vigor Reading | 8 days after Application 6 | 27% greater than control |
| | | P-value of 0.04 |
| Trunk Diameter | At time of Application 8 | 9% greater than control |
| | | P-value of 0.096 |
| Root growth- | At time of Application 8 | 12% greater than control |
| root length | | P-value of 0.048 |
| Root growth- | At time of Application 8 | 2% greater than control |
| root diameter | | P-value of 0.045 |

Data collection in Table 4 started in November 2015 with no fruit residing under the trees prior to sampling and continued through March 2016 and encompasses Applications 9-12. Fruit drop counts were taken at each of six sample periods. The mean fruit harvested, mean fruit drop, ratio of fruit harvested to fruit dropped, mean pounds fruit and mean pound solids are provided in Table 4.

TABLE 4

| | Example 1 | Example 2 | Example 3 | Control |
|---|---|---|---|---|
| Mean fruit | 443.7 | 352.7 | 398.7 | 363.8 |
| harvested | fruit/plot | fruit/plot | fruit/plot | fruit/plot |
| Mean fruit | 241.3 | 183.8 | 156.7 | 198.2 |
| dropped | fruit/plot | fruit/plot | fruit/plot | fruit/plot |
| Ratio of fruit | 1.89 | 1.98 | 2.55 | 1.95 |
| harvested to | | | | |
| fruit dropped | | | | |
| Mean pounds | 142.88 | 110.95 | 131.17 | 111.61 |
| fruit | pounds/plot | pounds/plot | pounds/plot | pounds/plot |
| Mean pound | 496 | 386 | 463 | 391 |
| solids | pounds/acre | pounds/acre | pounds/acre | pounds/acre |

Example 1 had the highest mean fruit harvested per plot and the highest mean fruit drop. There was not a statistical significant difference in the ratio of fruit harvested to fruit dropped for Example 1, Example 2 and the control.

In addition to having a greater number of fruit, Example 1 also resulted in more pounds of fruit per plot and had a higher mean pound solids per acre, which was calculated using formula (1).

$$Pound solids \text{/} acre = \frac{Pounds fruit per plot \times 54.45}{90} \times Pounds solids per box ( plot ) \qquad ( 1 )$$

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations that fall within the scope of the claims, together with all equivalents thereof.

What is claimed is:

1. A method to treat or prevent huanglongbing (HLB) in citrus plants, the method comprising:
applying a composition containing an auxin and cytokinin to the citrus plant, the auxin selected from the group consisting of indole-3-butryric acid (IBA), indole-3-acetic acid (IAA), naphthalene-1-acetic acid (NAA) and combinations thereof; and
repeating the step of applying the composition at least three additional times, wherein the applying steps are spaced at least 10 days but not more than 90 days apart.

2. The method of claim 1 wherein the auxin is IBA.

3. The method of claim 1 wherein the auxin is IAA.

4. The method of claim 1 wherein the auxin is NAA.

5. The method of claim 1 wherein the cytokinin is kinetin.

6. The method of claim 1 wherein the cytokinin is 6-benzylaminopurine (BAP).

7. The method of claim 1 and further comprising mixing a concentrate actives composition with water to form the composition, wherein the concentrate actives composition comprises from about 1 wt % to about 0.85 wt % of the auxin and from about 0.05 wt % to about 0.25 wt % of the cytokinin.

8. The method of claim 1 and further comprising mixing a concentrate actives composition with water to form the composition, wherein the concentrate actives composition comprises about 0.85 wt % of the auxin and about 0.15 wt % of the cytokinin.

9. The method of claim 1 and further comprising mixing a concentrate actives composition with water to form the composition, wherein the concentrate actives composition is mixed with water at a ratio from about 0.05% to about 0.5% volume concentrate actives composition to volume water.

10. The method of claim 1 and further comprising:
mixing a concentrate actives composition with water to form the composition; and
adjusting the pH of the water to about 7.0 to about 5.5 prior to mixing the water with the concentrate actives composition.

11. The method of claim 1 wherein the composition is free of strobilurins, carboxam ides, azoles, heterocyclic compounds, and carbamates.

12. The method of claim 1 wherein the composition further comprises a wetting agent.

13. The method of claim 1 wherein applying the composition comprises foliar application of the composition.

14. The method of claim 1 wherein at least one of the applying steps occurs during a root flushing period of the citrus plant.

15. The method of claim 1 applying steps are spaced at least 10 days but not more than 60 days apart.

16. The method of claim 1 wherein the citrus plant is an orange tree.

17. A method to treat or prevent huanglongbing (HLB) in citrus plants, the method comprising:
mixing a concentrate actives composition with water to form a composition, the concentrate actives composition comprising from about 1% to about 0.85% by weight of an auxin selected from the group consisting of indole-3-butryric acid (IBA), indole-3-acetic acid (IAA) and naphthalene-1-acetic acid (NAA) or a combination thereof, and from about 0.05% to about 0.25% by weight of a cytokinin; and
applying the composition by a foliar application to the citrus plant in at least four applications, wherein the applications are spaced at least 10 days but not more than 60 days apart.

18. The method of claim 17 wherein the applications are spaced at least 10 days but not more than 40 days apart.

19. The method of claim 17 wherein the composition is free of strobilurins, carboxam ides, azoles, heterocyclic compounds, and carbamates.

20. The method of claim 17 wherein the water has a pH from about 7.0 to about 5.5 when mixed with the concentrate actives composition.
